(19) United States
(12) Patent Application Publication
(10) Pub. No.: US 2025/0320946 A1
(43) Pub. Date: Oct. 16, 2025

(54) METHODS AND APPARATUS FOR PROVIDING ACCESS TO AN UNDERGROUND PIPE

(71) Applicant: PIPE LINING ENTERPRISES, INC., Fort Lauderdale, FL (US)

(72) Inventor: Larry W. Kiest, JR., Fort Lauderdale, FL (US)

(21) Appl. No.: 19/036,621

(22) Filed: Jan. 24, 2025

Related U.S. Application Data
(60) Provisional application No. 63/624,629, filed on Jan. 24, 2024.

(51) Int. Cl. F16L 55/10

(52) U.S. Cl. CPC F16L 55/10

(57) ABSTRACT

For minimally invasive pipe repair, such as cured-in-place pipe repair systems (i.e., CIPP), access is required to a host pipe of pipe system. The access to the host pipe will allow inspection, introduction of equipment, and even direct CIPP repair from the access point. The access can be achieved by removing soil from an area around an underground pipe, creating a hole into the underground pipe, and then attaching an access pipe (e.g., a cleanout pipe) to the buried pipe at the hole. The access pipe attachment can be held in place at the hole without mechanical means, such as by weight of the soil added back to a saddle portion of the access pipe. A seal can be included to aid in mitigating leakage into the pipe system. In addition, the hole can be honed after hole creation to mitigate damage to later introduced equipment.

### CROSS REFERENCE TO RELATED APPLICATIONS

This application claims priority under 35 U.S.C. § 119 to provisional patent application U.S. Ser. No. 63/624,629, filed Jan. 24, 2024. The provisional patent application is herein incorporated by reference in its entirety, including without limitation, the specification, claims, and abstract, as well as any figures, tables, appendices, or drawings thereof.

### TECHNICAL FIELD

The present disclosure relates generally to the field of trenchless pipe repair. More particularly, but not exclusively, the disclosure includes aspects including apparatus, systems, and/or methods that are directed towards the access and connection of underground pipes for the repair of one or more pipes of a pipe system.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

As the infrastructure of major cities and towns in the developed world age, the sewer systems weaken. Pipe degradation, system blockage, water infiltration, and sewer leakage are major problems that aging sewer systems experience. As these problems persist, the sewer system may eventually experience total failure and entire sections of the sewer system may collapse. As a result, sinkholes may form, and sewers may back up into homes and places of business. One method of addressing this critical infrastructure problem is the use of pipelining techniques to rehabilitate existing sewer systems.

Cured-in-place pipelining (CIPP) is one such technique that includes rehabilitating an existing sewer system by creating a new pipe within an existing pipe. A liner, impregnated with a resinous material capable of curing and hardening, is inverted or pulled into a damaged pipe. The liner is pressed against the wall of the existing pipe, and the resinous material is allowed to cure and harden. The result is a replacement pipe having the older pipe or “host pipe” on the exterior. The cured-in-place pipe acts to alleviate the problems caused by structural defects and blockages in the existing sewer system. Even in sewer systems where the main pipes have been rehabilitated with a cured-in-place pipe or other pipe liners, problems still arise.

Conventional sewer lines include a main pipe which extends along the street in a direction parallel to the street. Each house has a lateral pipeline that extends from the home and connects to the main pipeline. U.S. Pat. No. 9,562,339 provides a way in which the lateral pipe is lined using CIPP from a main pipe, which is a manhole. Still other patents, such as U.S. Pat. Nos. 9,435,479, 8,550,121, among others, disclose lining processes.

It is often desirable to provide a clean-out to the lateral pipe adjacent the main sewer pipe. Many lateral pipes have been buried without such a clean-out. One method to provide a clean-out is to make a wide and extensive excavation so that persons can enter the excavation and attach a clean-out pipe to the lateral pipe. This results in considerable disruption to the soil and the yard around the house. Another option utilizes minimally invasive methods, for example, U.S. Pat. Nos. 9,151,410, 6,705,801 are but some of the ways in which a clean-out is provided to a pipe.

With the minimally invasive methods for providing access, there are hurdles that exist. One such issue is maintaining connection between a host pipe and the new access pipe. To account for such an issue, mechanical fasteners have been used to hold the host and access pipe portions to one another. However, this leads to another issue, which includes leakage into the connection from groundwater at or near the connection. To account for this, seals, such as hydrophilic seals have been used. These seals generally expand in contact with water, and if they are placed between the host and access pipes, could create gaps that allow for further leakage into the pipe system.

Still further, as part of the process to provide the access to the host pipe a hole or other aperture is cut or created in the host pipe. This allows access into the pipe and to allow components related to the pipe repair (e.g., cameras, cleaning equipment, pressure, robots, other conduits, etc.) to enter the pipe system via the host pipe. At least some pipes used in pipe systems comprise clay. In clay and other pipes, a saw or drill is used to create the opening in the host pipe. This can leave sharp edges around the periphery of the cutout into the host pipe. The sharp or rough edges can cause damage to the components that are introduced into the pipe system before, during, or after the CIPP process.

Once an access hole has been established, there may be further issues, especially when attempting to follow a proper order of operations for the pipe repair. For example, it is beneficial to plug the upstream side of the lateral (i.e., upstream of the cleanout/access hole in the lateral pipe). This can be difficult when the cleanout pipe connects to the lateral pipe with a wye-shaped connection instead of a tee-shaped connection.

Thus, there exists a need in the art for an apparatus which improved systems and methods for providing access to a host pipe for CIPP repair of one or more pipes in a pipe system that overcomes such issues. There also exists a need in the art to provide a way to reduce sharp or rough edges in a cutout of a host pipe, as well as ensuring that the proper order of operations is followed for the pipe repair process.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of any of the aspects and/or embodiments of the present disclosure to provide access to a buried pipe. For example, the access can be accomplished with minimal invasiveness to the area adjacent to the pipe.

It is still yet a further object, feature, and/or advantage of any of the aspects and/or embodiments of the present disclosure of the present disclosure to improve the attachment and/or sealing of an access pipe to an underground host pipe.

It is still a further object, feature, and/or advantage of any of the aspects and/or embodiments of the present disclosure to mitigate damage to any equipment or components that are introduced to the host pipe after access has been provided. For example, the host pipe itself can be addressed to improve surfaces to lessen the likelihood of damage to components.

It is yet a further object, feature, and/or advantage of any of the aspects and/or embodiments of the present disclosure to aid in following a proper order of operations related to the repair of one or more pipes of a pipe system. This can include positioning of a plug at wye-shaped connections.

The systems and/or methods disclosed herein can be used in a wide variety of applications. For example, while access to an underground host pipe is often needed for CIPP repair of one or more pipes of a pipe system, the access could also be used for inspection, measuring, or other information from interior of the pipe system.

It is preferred the systems and methods disclosed be safe, cost effective, and durable. For example, the host pipe access by any of the systems and/or methods disclosed can be adapted to resist excessive heat, static buildup, corrosion, and/or mechanical failures (e.g., cracking, crumbling, shearing, creeping) due to excessive impacts and/or prolonged exposure to tensile and/or compressive forces acting on the pipe system.

Methods can be practiced which facilitate use, manufacture, assembly, maintenance, and repair of a host pipe access, which accomplish some or all of the previously stated objectives.

The systems can be incorporated into or kits which accomplish some or all of the previously stated objectives.

According to some aspects of the present disclosure, a method of providing access to an underground pipe comprises excavating the ground to expose a portion of the underground pipe; positioning a saddle to the exposed portion of the underground pipe, the saddle comprising a curved plate and a boss extending from the curved plate, wherein the curved plate has a first side facing the underground pipe and a second side away from the underground pipe, and wherein the first side of the curved plate includes a generally circular channel extending into the first side; creating a bore into the underground pipe at the boss and saddle; and adding the excavated ground to the curved plate of the saddle to hold the saddle in place at the underground pipe.

According to at least some aspects of some embodiments, the method further comprises providing an adhesive between the saddle and the underground pipe.

According to at least some aspects of some embodiments, the method further comprises positioning a seal in the channel at the first side of the saddle to mitigate leaking.

According to at least some aspects of some embodiments, the seal comprises a hydrophilic material.

According to at least some aspects of some embodiments, the seal comprises a hydrophilic O-ring.

According to at least some aspects of some embodiments, the method further comprises adding a weighted material with the excavated soil to provide additional weight to hold the saddle in place at the underground pipe.

According to at least some aspects of some embodiments, the method further comprises honing the bore in the underground pipe.

According to at least some aspects of some embodiments, the step of honing the bore comprises inserting a honing tool through the bore, wherein the honing tool contacts substantially all surfaces and edges of the bore.

According to at least some aspects of some embodiments, the honing tool comprises a plurality of carbide members spun about an axis.

According to additional aspects of the present disclosure, a method of providing access to an underground pipe comprising excavating the ground to expose a portion of the underground pipe; positioning a saddle to the exposed portion of the underground pipe, the saddle comprising a curved plate and a boss extending from the curved plate, wherein the curved plate has a first side facing the underground pipe and a second side away from the underground pipe; creating a bore into the underground pipe at the boss and saddle; and honing the bore in the underground pipe.

According to at least some aspects of some embodiments, the step of honing the bore comprises inserting a honing tool through the bore, wherein the honing tool contacts substantially all surfaces and edges of the bore.

According to at least some aspects of some embodiments, the honing tool comprises a plurality of carbide members spun about an axis.

According to at least some aspects of some embodiments, the first side of the curved plate includes a generally circular channel extending into the first side.

According to at least some aspects of some embodiments, the method further comprises positioning a seal in the channel at the first side of the saddle to mitigate leaking.

According to at least some aspects of some embodiments, the seal comprises a hydrophilic material.

According to at least some aspects of some embodiments, the seal comprises a hydrophilic O-ring.

According to at least some aspects of some embodiments, the method further comprises adding the excavated ground to the curved plate of the saddle to hold the saddle in place at the underground pipe.

According to additional aspects of the present disclosure, a method of providing access to an underground pipe comprises excavating the ground to expose a portion of the underground pipe; positioning a saddle to the exposed portion of the underground pipe, the saddle comprising a curved plate and a boss extending from the curved plate, wherein the curved plate has a first side facing the underground pipe and a second side away from the underground pipe; creating a bore into the underground pipe at the boss and saddle; honing the bore in the underground pipe; and adding the excavated ground to the curved plate of the saddle to hold the saddle in place at the underground pipe.

According to at least some aspects of some embodiments, the first side of the curved plate includes a generally circular channel extending into the first side, and further comprising providing an adhesive between the saddle and the underground pipe and comprising positioning a seal in the channel at the first side of the saddle to mitigate leaking.

According to at least some aspects of some embodiments, the seal comprises a hydrophilic O-ring.

According to still additional aspects of the present disclosure, a system for providing access to an underground pipe comprises a curved plate and a boss extending from the curved plate; wherein the curved plate has a first side facing the underground pipe and a second side away from the underground pipe; and wherein the first side of the curved plate includes a generally circular channel extending into the first side.

According to at least some aspects of some embodiments, the system further comprises a seal in the channel at the first side of the saddle to mitigate leaking.

According to at least some aspects of some embodiments, the seal comprises a hydrophilic material.

According to at least some aspects of some embodiments, the seal comprises a hydrophilic O-ring.

According to at least some aspects of some embodiments, the curved plate includes outwardly flared flanges at ends thereof.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a depiction of a pipe system such that may include access via a cleanout pipe.

FIG. 2 is a sectional view of a portion of a pipe system showing a buried lateral and main sewer pipe and a pipe access device for providing access to the interior of the lateral sewer pipe.

FIG. 3 is a sectional view of FIG. 2 from an end view of the lateral pipe.

FIG. 4 is a perspective view of a lateral and main pipe with a pipe access device positioned to provide access to the lateral pipe.

FIG. 5 is a bottom perspective view of a pipe access device according to aspects and/or embodiments of the present disclosure.

FIG. 6 is a depiction of a bore into a lateral pipe at the pipe access device showing rough or sharp edges of the bore opening.

FIG. 7 is a depiction of the bore showing a honing tool being inserted in the bore to hone the bore.

FIG. 8 is another view of the honing tool further inserted in the bore to hone the same.

FIG. 9 is a view of a honed bore after the tool has been removed to show smooth portions of the bore.

FIG. 10 is a view showing the honing tool according to aspects and embodiments of the present disclosure.

FIGS. 11A-11C disclose the positioning of a plug at an upstream side of a lateral pipe relative to a cleanout.

FIG. 12 is a sectional view of a portion of a lateral pipe and cleanout showing the positioning of a plug.

FIG. 13 is another sectional view of a lateral pipe and cleanout showing a plug at an upstream side of the cleanout in the lateral pipe.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

A “pipe liner” is defined as a material that is used to provide a lining to a pipe. Pipe liners include but are not limited to cured-in-place pipe liners, folded liners, or spray-on liners. A “cured-in-place pipe liner” is a fabric capable of holding a resinous material.

A “folded liner” is a material constructed of a thermoplastic, such as High Pressure Polyethylene (“HPPE”), High Density Polyethylene (“HDPE”), Medium Density Polyethylene (“MDPE”), Polyvinyl Chloride (“PVC”), and/or modified PVC that is used to provide a lining to pipes.

A “main liner” or “main pipe liner” is defined as a pipe liner for use inside of a main sewer pipe.

A “manhole liner” is defined as a material that is used to provide a lining to a manhole. Manhole liners include but are not limited to cured-in-place manhole liners, spray-on manhole liners, cementitious manhole liners, cast-in-place manhole liners, and resin manhole liners.

A “cured-in-place manhole liner” is a fabric or textile capable of holding a resinous material and conforming to a manhole structure.

A “spray-on liner” is defined as a material that is used to provide a lining to a manhole or pipe where the material is sprayed onto the walls of the manhole or pipe.

A “cementitious liner” is defined as a cement material that is used to provide a lining to a manhole. Cementitious liners may usually be sprayed, spread, or otherwise placed onto the walls of the manhole.

A “resin liner” is defined as a resinous material that is used to provide a lining to a manhole. Resin liners may be sprayed, spread, or otherwise placed onto the walls of the manhole.

A “service pipe” is defined as a pipe that is lateral to a main pipe.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

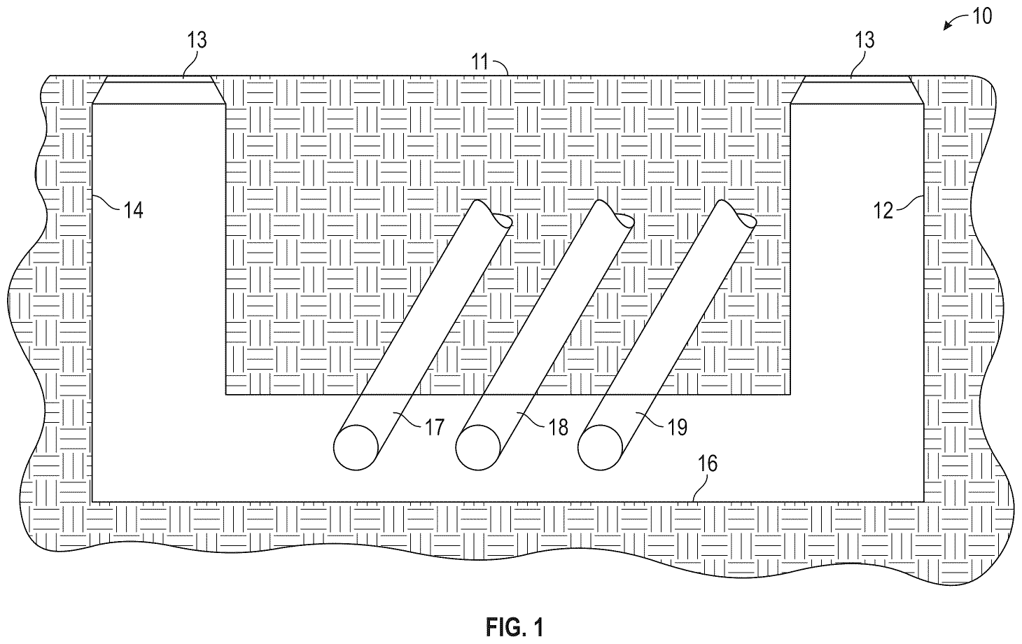

FIG. 1 is an exemplary sectional view of a pipe system 10. The pipe system 10 is not to be limiting on the present disclosure, and instead, is used for understanding a potential environment. The pipe system 10 includes an upstream manhole 12 and a downstream manhole 14. The manholes include manhole covers 13 at or near the grass, ground, or other surface, making the pipe system be located underground. Connecting the up and downstream manholes 12, 14, and extending generally therebetween is a main pipe 16. Extending from the main pipe are a number of lateral or service pipes. The service pipes shown in the pipe system 10 include a first service pipe 17, second service pipe 18, and a third service pipe 19.

The number and/or orientation of the service pipe extending from a main pipe is not to be limiting to the invention, it is to be considered that any orientation and/or number of service pipes may be included, depending on the set up of a pipe system. However, for purposes of disclosure and understanding, the use of the three service pipes in FIG. 1 is provided. In conventional systems, the walls of the various components of the pipe system, such as that shown in FIG. 1, may comprise concrete, vitrified clay pipe, cast iron or like materials. As will be understood, according to at least some embodiments disclosed, the aspects of the invention include the repair of the pipe system during the introduction and securing of the conduit in a pipe system, such as may be referred to as cured in place pipe repair (CIPP).

A cured in place pipe (CIPP) is a trenchless rehabilitation method used to renovate existing pipelines. CIPP has applications in sewer, water, gas, and chemical pipelines of various diameters. As is known, the process of CIPP involves inserting and running a felt lining into a preexisting pipe subject of repair. Thermoset resin or other suitable material capable of curing and hardening is impregnated into a liner is exposed to a curing element to allow the liner to cure and harden, forming a new internal surface or wall of the pipe.

In addition, it should be appreciated that the introduction and/or the curing of a one or more CIPP liners in a pipe system need not be done at the same time of the installation of the conduits/fiber cables and can be simply installed and secured in-place using any of the aspects as will be disclosed here.

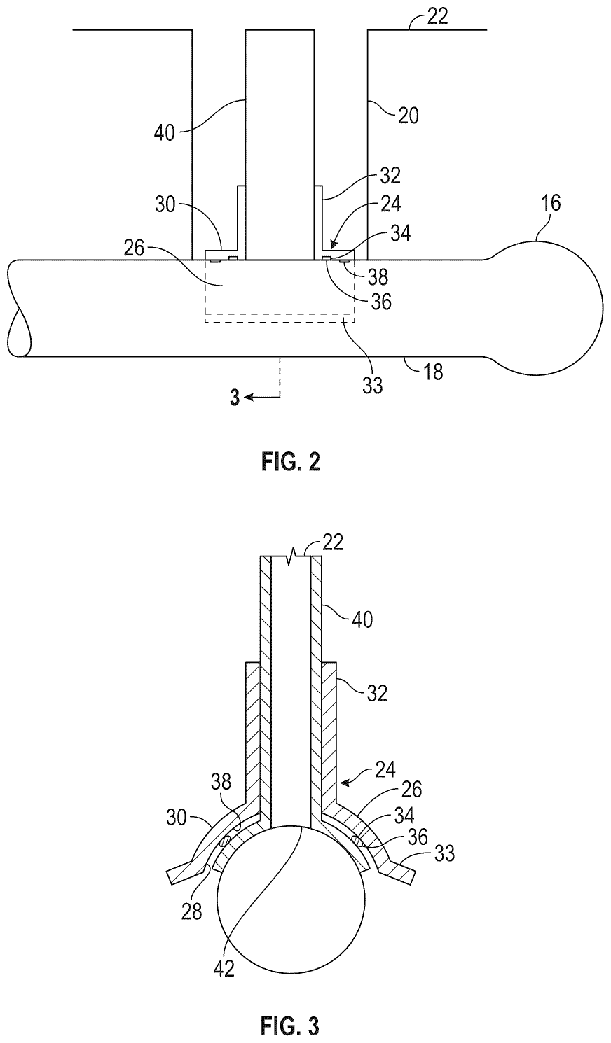

At least some instances of pipe repair, pipe access, pipe inspection, pipe cleaning, or otherwise entering one or more of the pipes requires accessing one of the underground pipes, such as via a cleanout pipe. For example, as noted in U.S. Pat. No. 11,624,469, a preferred and/or best method for repairing one or more pipes of a pipe system includes providing access to one or more of the underground pipes by creating a newly formed access pipe, which may also be referred to as a cleanout pipe. Such a configuration is shown in FIG. 2.

The cleanout pipes, also referred to as access pipes, provide numerous advantages. Pipe repair can be complete directly from the cleanout pipe. Plugs or cameras can be introduced into the pipe via the cleanout, so as to allow for inspection, measuring, or even control of the repair process such as by blocking certain parts of the pipe system before, during, or after the pipe repair has occurred.

Providing access to underground pipes via cleanouts or access pipes are known. Generally, the process includes excavating a portion of the ground 22 to a depth where a portion of the underground pipe (shown in FIG. 2 to be a lateral pipe 18 extending from a main pipe 16) becomes accessible. According to some methods, the amount of ground/earthen material removed will be a wider diameter than a later installed access pipe but will be minimal to minimize disruption to the area of excavation, which may be a homeowner's yard. The excavation can take many forms, including, but not limited to, vacuum trucks, digging, or the like. The manner of ground removal is not to be limiting on the disclosure. However, it should be appreciated that the removed ground is to be maintained for later use, as will be understood.

Once the ground 22 has been removed to provide the access to the exterior of the underground lateral pipe 18, the next steps can be taken to provide access to the interior of said pipe. First, a pipe access device, such as a saddle 24, can be positioned on the exterior of the pipe 18. The saddle 24 includes a curved portion 26 that will surround at least a portion or the pipe 18 and includes a boss portion 32 extending from the curved portion. The boss 32 comprises a circular or near circular extension that extends from the curved portion 26 towards the surface of the ground, and as will be understood, provides the start of an extension or elongated pipe that will extend towards the ground surface.

The saddle 24 can comprise a number of materials, including plastics or other polymers. For example, the saddle could be molded to include certain features, such as grooves or channels in one or more surfaces, as will be understood herein.

The curved portion 26 of the saddle 24 comprises a first side 28 and a second side 30. The first side 28 may also be referred to as the underside and is the side of the curved portion 26 that faces the pipe 18. The second side 30 is the opposite side of the curved portion 26, and the distance between the first and second sides 28, 30 constitutes the thickness of the curved portion 26 of the saddle 24. The length of the curved portion 26 of the saddle 24 around the pipe 18 may vary. For example, according to some embodiments, the length of the curved portion extends less than half of the curvature (i.e., circumference) of the pipe. In at least some aspects of the disclosure, the curved portion may span at least have of the circumference of the pipe 18 or even more than have of the circumference. Therefore, it should be appreciated that the length of the curved portion 26 around the pipe 18 is not to be limiting to the disclosure. It is also noted that the curved portion includes outwardly flared flanges 33 at the ends of the curved portions on either side of the pipe 18.

Therefore, as is understood, the saddle 24 is placed at or on the pipe 18 with the boss 32 extending away from the pipe. The saddle 24 will be held in place at the pipe 18 with an elongated pipe 40 positioned to or adhered at the boss 32 of the saddle 24 to allow access to the pipe 18 from an exterior location. Prior to the positioning of the elongated pipe portion, a bore or hole 42 is made through the pipe at the saddle 24 to provide access to an interior of the pipe 18.

An extension pipe can have an extension pipe bore extending therethrough. The extension pipe has a first end telescoped with respect to upper end of boss bore. It should be noted that the extension or elongated pipe can be connected to the saddle before the system is lowered into contact with the underground pipe, or the extension/elongated pipe can be added once the saddle has been positioned on the underground pipe.

The bore 42 can be created after placement of the saddle 24 at the pipe 18 so as to aid in aligning the saddle 24, boss 32, and elongated pipe 40 with the bore 42. According to some embodiments, the bore is cut, such as with a saw, through the pipe wall. For example, when the pipe 18 comprises clay, the clay pipe can be cut using known tools to create the bore 42 therethrough. The placement of the saddle 24, along with the cutting of the bore and the extension of the elongated pipe 40 will provide the access into the lateral pipe 18 from an exterior location, such as at or near the surface of the ground 22.

However, as there is now a hole in the pipe 18, it is important to ensure that the leakage from the interior and into the interior of the pipe is mitigated, especially at the newly created bore 42 and the area around the same. There are a few key issues that need addressed with the addition of the saddle and bore. One is keeping the saddle 24 as closely to the pipe 18 as possible to mitigated leakage into or out of the pipe. In addition, it may be beneficial to increase the sealing at the saddle/bore location, such as with a hydrophilic member to further mitigate leakage.

Therefore, additional aspects of the disclosure will aid in improving these measures. For example, as shown best in FIGS. 2, 3, and 5, one feature of the saddle 24 includes a channel 34 at the first side 28 of the curved portion 26. The channel 34 comprises a recessed portion into the thickness of the curved portion 26, meaning that a portion of the curved portion is removed at the channel 34, or that the channel 34 is recessed or sunken towards the second side 30 of the curved portion. In other words, the channel 34 comprises an area with less thickness between the first and second sides of the curved portion 26.

The channel 34 can be used to position a seal 36 between the saddle 24 and the exterior surface of the pipe 18 to further mitigate leakage into or out of the pipe at or near the bore 42. The channel 34 is located to receive a portion of the seal 36 to lessen the added thickness caused by the addition of the seal to aid in holding the saddle in place at the exterior of the pipe 18. The seal 36 can take different forms. According to some aspects of some embodiments, the seal 36 can comprise a hydrophilic material that matches or substantially matches the same and size of the channel 34. For example, the seal 36 can comprise a hydrophilic O-ring that is positioned at least partially in the channel 34 to provide the additional sealing around the bore 42. In addition, it should be noted that the seal comprise hydrophilic polymer, such as rubber, or can comprise other hydrophilic materials, such as pastes, rings, gaskets, or the like. Still further, the makeup of the seal may not be hydrophilic, and instead comprise materials that will provide similar leak-mitigation.

As is known with hydrophilic materials, they will generally expand, at least partially, when contacting a liquid, such as water. This expansion may cause issues to the pipe access at the saddle 24, such as creating new spacing between the saddle and the pipe for liquids to encroach. Therefore, in addition to the seal, addition aspects of the disclosure are provided. An adhesive 38 may be placed between the first side 28 of the curved portion and the exterior of the pipe 18, such as both interior of and exterior of the channel on the first side of the curved portion. The adhesive can be a resin (such as an uncured plastic resin) or other material that will aid in holding the saddle at or to the pipe 18. Such a non-mechanical fastening will not require any additional holes through the saddle 24 or the pipe 18, which enhances the integrity of the pipe access system.

The use of hydrophilic materials in a channel or groove is advantageous because the material not only stays in place but has as it swells, all the force comes out of the groove towards the opposing pipe wall to make a significant seal. In another embodiment, the gasket could be hydrophilic paste and that paste could be in a liquid form where the material would be smashed really thin or it could be applied to the groove and allowed to solidify and act as a gasket when hydrated. In yet another embodiment, the gasket could be a sheet of expanding rubber that covers the entire interior surface of the saddle.

In addition, once the pipe access system, including the saddle, seal, and elongated pipe have been positioned to provide access to the pipe, additional measures can be taken to further hold the components in place and to mitigate leakage or displacement of said components. As noted, earthen material is removed (e.g., excavated) initially to provide access to an exterior of the pipe 18 underground, and said material is maintained. After access to the interior of the pipe is established via the saddle and elongated pipe, the earthen material can be re-added to the area around the saddle and elongated pipe section to both fill in the ground and to provide weight to hold the saddle in place at the pipe, even after expansion of any sealing member due to contact with a liquid (e.g., water).

It has been determined that with certain adhesives, it takes approximately 1650 lbf when the full first side of the curved portion includes the adhesive around the pipe. However, it is also noted that the inclusion of the seal 36 in the channel 34 will cause some discontinuity of the adhesive, as the adhesive will not be able to be positioned at the location of the seal 36. In addition, as noted, the seal 36 will expand if contacted with water and such expansion will exert a force between the first side 28 of the saddle 24 and the pipe 18, which will also disrupt the adhesive properties. Previous attempts have been made to aid in holding the saddle in place and include the use of mechanical fasteners between a portion of the saddle and the pipe to provide additional support to hold the components in place. However, as mentioned, the inclusion of such mechanical fasteners creates new areas of weakness and also potential areas of leaking.

Therefore, to address such issues, aspects of embodiments of the present disclosure include the use of the removed earthen material to further hold the saddle in place without the use of any mechanical fasteners. This includes the earthen material from the area where the elongated pipe and saddle now reside, meaning that the same amount of material can be re-added in less area, which will increase the amount of weight and force acting on the saddle at the pipe. Such a packing of the earthen material will aid in holding the saddle in place at the pipe without the use of the mechanical fasteners and will mitigate spacing between the saddle and the pipe.

Still further, it is noted that if there is a desire to further increase the force on the saddle by the earthen material, extra weighted material can be added with the earthen material. For example, rocks, flowable concrete, powders, and the like that have greater density than the earthen material itself can be mixed with the earthen material and then added and potentially packed together to provide yet additional weight and forces on the saddle to aid in holding the saddle in place at the pipe, even if and when the seal expands.

As can be appreciated, an advantage of having the groove or channel 34 is that, as the gasket or seal 36 expands, it can only expand from the channel 34 towards the pipe, thereby exerting all of the force to form a seal against the pipe.

Therefore, the soil weight keeps the saddle in contact with the pipe as the gasket expands and makes a seal. In addition, there is a clamping effect of the saddle that extends beyond a spring line of the pipe. Once a suitable fill, such as sand or other approved aggregate, is compacted between the undisturbed earth and the saddle, it becomes nearly impossible to remove the saddle from the pipe because the side walls of the saddle must spread apart at least to the point of the pipe spring line in order to be removed from the pipe. There is the force necessary to spread the side walls, then there is the force necessary to spread the side walls with fill packed between the earth and the side walls of the saddle making it nearly impossible to remove the saddle or to even allow it to raise up.

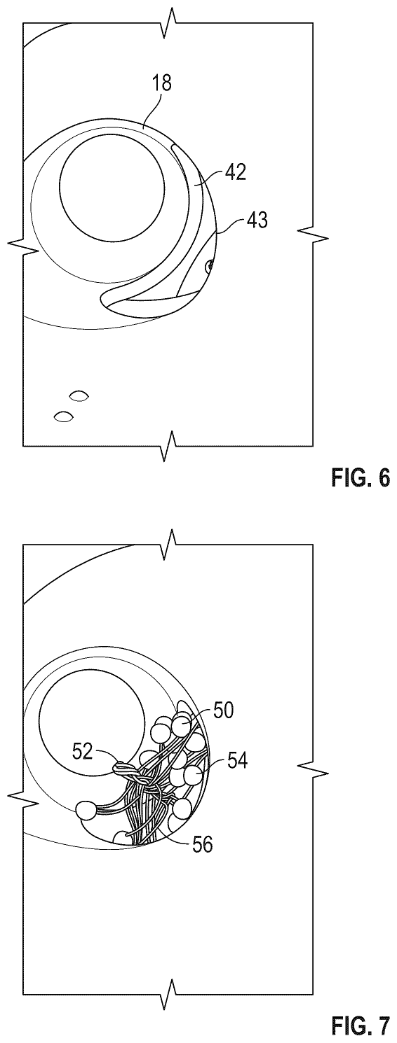

Additional improvements are included and shown in FIGS. 6-10. As noted, part of the process includes positioning the saddle 24 at the exterior of the pipe 18 and then creating a bore 42 in the pipe through the saddle 24. Pipes generally comprise clay or concrete, and the creation of the bore 42 constitutes cutting or otherwise making a rough removal of the pipe material. As shown in FIG. 6, such a rough cutting can create rough edges/surfaces 43 at the bore 42 due to the material of the pipe. The roughness can cause problems for later inserted entrants into the pipe, including conduits, pipe repair (e.g., CIPP) materials, inspections components, cleaning components, and the like. These are generally controlled via some sort of cable, conduit, or other material that can be damaged by the rough edges/surfaces at the newly created bore 42.

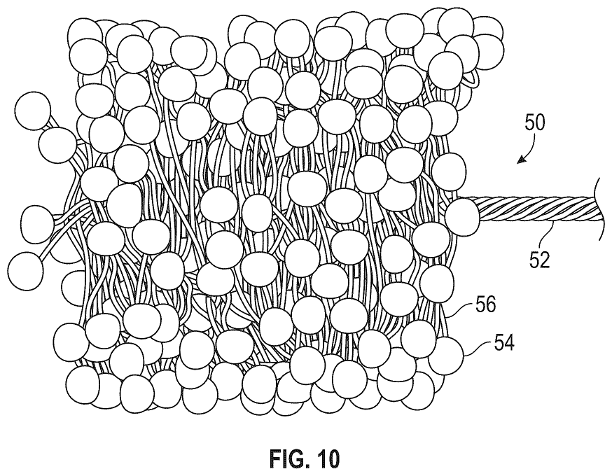

Therefore, as part of the system and methods for providing access to the pipe, additional aspects of at least some embodiments included herein include the introduction and use of honing tool 50, which is best shown in FIGS. 7-10. Attention is first given to FIG. 10, wherein at least some aspects of some embodiments of a honing tool are shown. The tool 50 comprises a central axis 52. A plurality of members 54 are connected to the central axis 52, such as via connectors. According to some embodiments, the members 54 comprise carbide, such as in the general shape of spherical members attached to the central axis 52 via metal connectors 56. However, it should be noted that other shapes and materials capable of smoothing or honing clay or concrete could be utilized. In addition, the number of members 54 and/or length of connectors may vary.

The central axis 52 is connected to a spinning member, such as a power tool (not shown). According to some embodiments, the power tool is a drill or other member that will spin the tool 50 at high speeds. The axis 52 is shown to be a metal member that will withstand the forces of the spinning tool against the walls/edges of the bore.

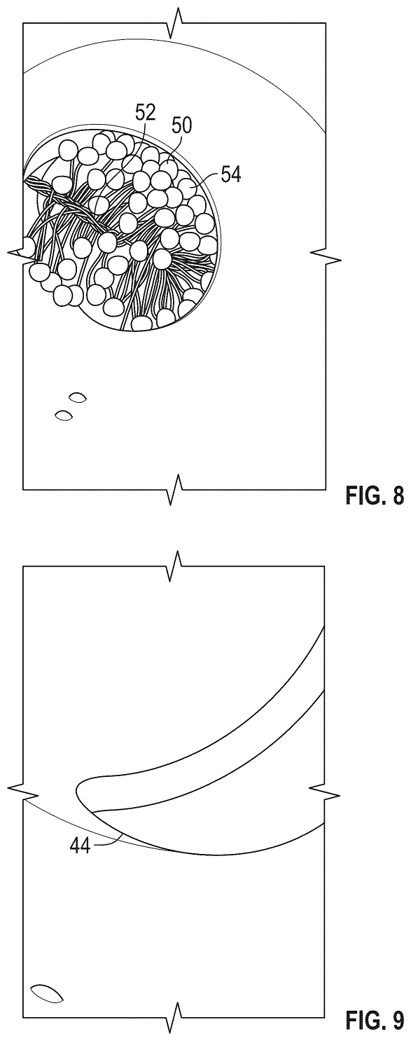

Moving back to FIG. 7, after the bore 42 is cut through the pipe wall, the honing tool 50 can be introduced. The tool 50 will be activated (i.e., spun via the spinning mechanism) as it is inserted slowly into the pipe 18 via the bore 42. As the connectors 56 between the members 54 and the axis 52 are flexible and durable, the various carbide members 54 will begin contacts the surfaces/edges of the bore and pipe. As shown in FIG. 8, the tool 50 is continued to be inserted into the pipe 18 so that the plurality of carbide members 54 are able to contact substantially all of the created bore, including all surfaces and edges thereof.

According to at least some aspects of some embodiments, the plurality of carbide members 54 comprise ball (i.e., spherical-shaped) shaped components. The spherical or ball shapes provide better contacting capabilities between the members and the walls/edges/surfaces of the pipe and bore to better hone the bore and pipe. However, it should be noted that the carbide members can take other shapes or could even be multi-shaped for a single tool. Still further, while carbide has been noted as one material for makeup of the tool members, it should be noted that other materials capable of contacting and smoothing portions of clay and concrete pipes could be used.

FIG. 9 shows a portion of the pipe 18 after the tool 50 has contacted and honed the bore 42 of the pipe. The tool 50 is configured to interact and smooth out the portions of the bore and adjacent areas, and as shown, there are fewer (if any) rough or sharp portions that could damage, catch, or otherwise affect the entrance of a component into the pipe via the bore. Also shown in the figure is dust or particles where the rough portions have been worn down by the honing tool 50 to create the smoother surfaces.

While not shown, it should be appreciated that the honing tool 50 could be operated by generally any member that will provide rotation to the plurality of members 54 (i.e., the carbide members). According to at least some aspects of some embodiments, a hand power tool could be used. A power tool is a tool that is actuated by an additional power source and mechanism other than the solely manual labor used with hand tools. Non-limiting examples of such power tools could include wired or wireless (e.g., battery operated) hand tools, such as rotary tools, impact wrenches, or other powered drills. The tools provide the rotational movement for the tool to more quickly hone the bore. However, hand tools, including hand powered sanding tools and hand-rotated mechanisms could also be used to provide the needed movement for the tool.

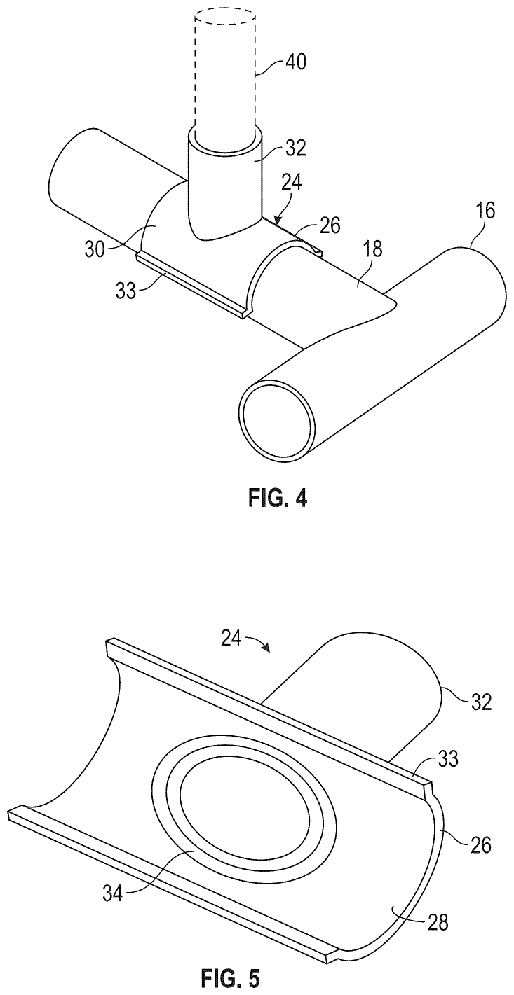

Moving back to FIGS. 2-5, the methods for providing the access and then providing the forces to hold the saddle in place are generally as follows. The ground is excavated to provide access to an exterior of an underground pipe 18. The ground material is maintained. A saddle 24 with curved portion 26 and boss 32 is positioned at the exterior of the pipe 18. A seal 36, such as a hydrophilic material, is positioned in a groove or channel 34 between the curved portion and the pipe. An adhesive material is also provided between the curved portion and the pipe at both sides or one side of the groove or channel. Once the adhesive has set, a bore is created through the pipe 18. The bore 42 can be honed using a tool as disclosed herein. An elongated extension pipe can be connected to the saddle to provide the needed access from an area exterior of the pipe.

The excavated material, either alone or with a weighted material added, can be added to backfill the area around the pipe and saddle to hold the components in place. The seal partially inset in the groove or channel will mitigate water or other unwanted fluids from entering into the pipe system at or near the bore. The weight of the material, along with the adhesive, will keep the components together, even if the hydrophilic seal expands due to the presence of water or other liquid.

As should be appreciated, the steps provided herein can be used in a proper order of operations for repairing one or more pipes of a pipe system, such as that disclosed herein. As noted in U.S. Pat. No. 11,624,469, which is hereby incorporated by reference for its written description and figures, a proper order of operations is a detailed discussion of how many quality procedures can be implemented to install a mainline liner and/or lateral liner following a step by step process resulting in a consistent quality CIPP installation. The order of operations controls the quality of the CIPP. There are significant advantages by simply changing the order of operations and installing service cleanouts on all service pipes and plugging the pipe to ensure system flows are stopped before lining the main pipe. The order of operations provides for a higher quality CIPP and ensures residents are protected from unpleasant odors that could be harmful.

As part of the order of operations, a cleanout, such as using the systems and methods disclosed herein, is used to provide access to a lateral pipe. The lateral pipe is then removed from service on an upstream side of the cleanout, such as via an inflatable plug. This mitigates any material from flowing into the lateral pipe from the house, residence, or other structure during the repair of the lateral pipe. When the cleanout and lateral pipe form a tee shaped juncture, this can be easily to place the plug. However, there are times when the juncture of the cleanout and the lateral pipe are in a wye shaped juncture. This makes it more difficult to position the plug on the upstream side of the cleanout in the lateral pipe.

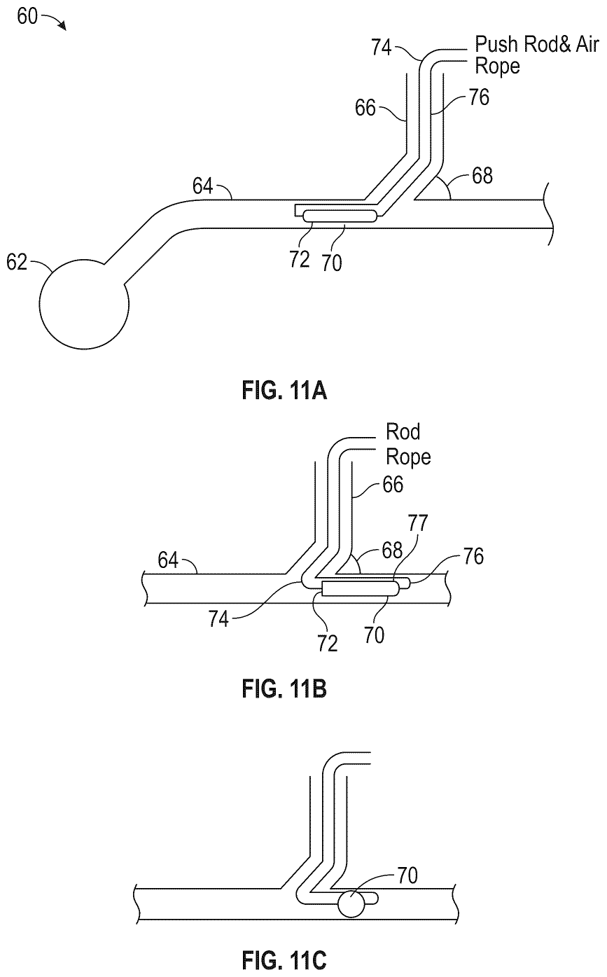

One example of such a situation is shown in FIGS. 11A-11C. As shown in FIG. 11A, a lateral pipe 64 extends from a main pipe 62 of an example pipe system 60. A cleanout 66 has been provided to access the lateral pipe 64. Note that the juncture 67 of the cleanout 66 and lateral pipe 64 is in a wye shape, which is at an angle (represented by arch 68 in the figures) less than 90-degrees. It is desirable to place a plug 70 at an upstream side of the cleanout 66 in the lateral pipe 64. In the figures, the upstream side is to the right of the cleanout 66, which is away from the main pipe 62, and which would lead to a residence, building, or other structure (not shown).

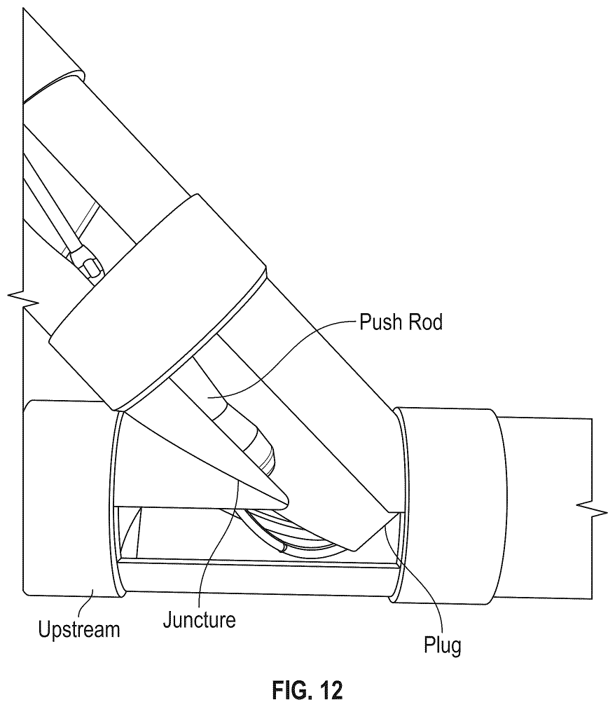

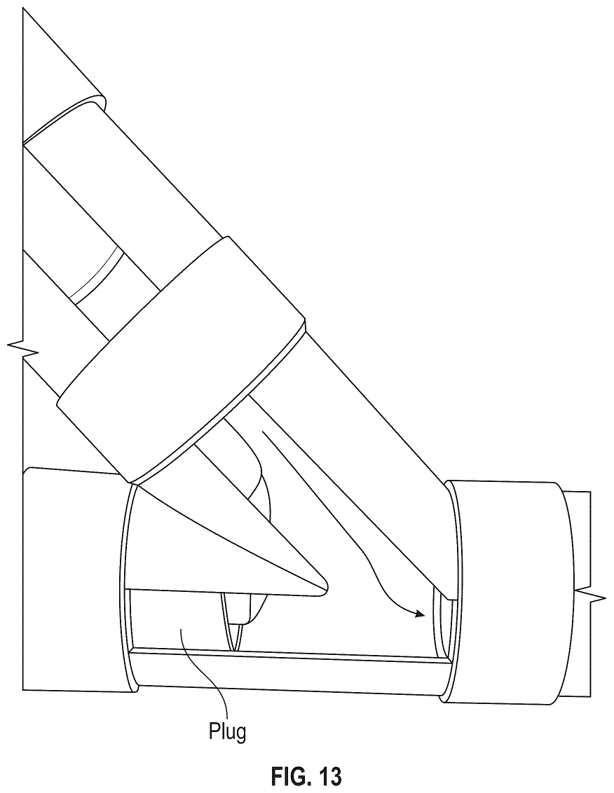

According to some aspects of some embodiments, the plug 70 may be a sausage style, inflatable plug that includes a front end 72. The front end 72 also includes an air inlet 73 for the inflatable plug 70. A push rod 74, which may also include the air hose for inflating the plug 70, is used to push the front end 72 of the plug into the lateral pipe 64 via the cleanout 66. The pushing rod/device 74 can be a fiberglass rod or spring steel flat stock. Still further, the push rod can comprise a pipe with a flexible hose hear the plug. The plug itself could be a flow-through style plug, such as shown and described in U.S. Ser. No. 18/158,956, the description of which is hereby incorporated by reference. Such a configuration would allow pump flow though the pipe to maintain service in the lateral/service pipe. For example, the configuration shown in FIGS. 12 and 13 include such a plug with flow through to a pipe connected to the plug. A pump or vacuum could be connected at an external end of the pipe and also to a reservoir or tank to allow the contents of the upstream side of the lateral pipe to maintain in service during the repair of the pipe system.

A rope 76 is connected to a second or rear end 77 of the plug 70. Once the plug 70 is in the lateral pipe 64, the rope can be pulled back to maneuver the plug to the upstream side of the cleanout in the lateral pipe 64. The plug 70 in the lateral 64 with the small rope passing over the plug is now in position (see, e.g., FIG. 11B). Air is added to inflate the plug and seal the lateral pipe (see, e.g., FIG. 11C). When finished, the plug is deflated. The rope is pulled and push rod pushed to maneuver the plug and to remove the plug up and out of the cleanout.

According to additional embodiments and/or aspects thereof, a plug could be positioned at the end of a push rod or member and attached to an air hose. The push rod could maneuver the plug through the cleanout to the juncture of the cleanout and lateral pipe. The plug can be positioned at an angle at the end of the push rod that coincides with the angle of the upstream portion of the lateral pipe relative to the cleanout. The push rod/plug is moved through the cleanout and when at the juncture (see, e.g., FIG. 12), can be rotated to position the plug into the upstream side of the lateral from the cleanout (see, e.g., FIG. 13). The plug can be inflated during repair of the lateral pipe. To remove, the plug is deflated and the plug/push member is rotated to disengage the angled juncture to allow the plug to be removed by removal of the push member.

Therefore, the methods and systems disclosed provide numerous advantages and/or improvements to providing access to an underground pipe. These include the omission of any mechanical or clamping means to hold a saddle in place at an underground pipe. Still further, the use of the seal inset in a groove or channel that is recessed into a portion of the saddle will mitigate separation between the saddle and the pipe, such as due to the expansion of the seal. Using the excavated material either alone or with an environmentally safe addition, such as a flowable fill material will minimize disruption of the ground and also provide the needed weight to hold the components in place. The systems and methods provided are a minimally invasive way to provide the access to the pipe, which can then allow a number of opportunities, such as repairing one or more pipes, inspecting the pipes, cleaning the pipes, or even preserving the ability to operate within the pipe system at a future date.

1. A method of providing access to an underground pipe, the method comprising:
excavating the ground to expose a portion of the underground pipe;
positioning a saddle to the exposed portion of the underground pipe, the saddle comprising a curved plate and a boss extending from the curved plate, wherein the curved plate has a first side facing the underground pipe and a second side away from the underground pipe, and wherein the first side of the curved plate includes a generally circular channel extending into the first side;
creating a bore into the underground pipe at the boss and saddle; and
adding the excavated ground to the curved plate of the saddle to hold the saddle in place at the underground pipe.

2. The method of claim 1, further comprising providing an adhesive between the saddle and the underground pipe.

3. The method of claim 1, further comprising positioning a seal in the channel at the first side of the saddle to mitigate leaking.

4. The method of claim 3, wherein the seal comprises a hydrophilic material.

5. The method of claim 3, wherein the seal comprises a hydrophilic O-ring.

6. The method of claim 1, further comprising adding a weighted material with the excavated soil to provide additional weight to hold the saddle in place at the underground pipe.

7. The method of claim 1, further comprising honing the bore in the underground pipe.

8. The method of claim 7, wherein the step of honing the bore comprises inserting a honing tool through the bore, wherein the honing tool contacts substantially all surfaces and edges of the bore.

9. The method of claim 8, wherein the honing tool comprises a plurality of carbide members spun about an axis.

10. A method of providing access to an underground pipe, the method comprising:
excavating the ground to expose a portion of the underground pipe;
positioning a saddle to the exposed portion of the underground pipe, the saddle comprising a curved plate and a boss extending from the curved plate, wherein the curved plate has a first side facing the underground pipe and a second side away from the underground pipe;
creating a bore into the underground pipe at the boss and saddle; and
honing the bore in the underground pipe.

11. The method of claim 10, wherein the step of honing the bore comprises inserting a honing tool through the bore, wherein the honing tool contacts substantially all surfaces and edges of the bore.

12. The method of claim 11, wherein the honing tool comprises a plurality of carbide members spun about an axis.

13. The method of claim 10, wherein the first side of the curved plate includes a generally circular channel extending into the first side.

14. The method of claim 13, further comprising positioning a seal in the channel at the first side of the saddle to mitigate leaking.

15. The method of claim 14, wherein the seal comprises a hydrophilic material.

16. The method of claim 14, wherein the seal comprises a hydrophilic O-ring.

17. The method of claim 10, further comprising adding the excavated ground to the curved plate of the saddle to hold the saddle in place at the underground pipe.

18. A method of providing access to an underground pipe, comprising:
excavating the ground to expose a portion of the underground pipe;
positioning a saddle to the exposed portion of the underground pipe, the saddle comprising a curved plate and a boss extending from the curved plate, wherein the curved plate has a first side facing the underground pipe and a second side away from the underground pipe;
creating a bore into the underground pipe at the boss and saddle;
honing the bore in the underground pipe; and
adding the excavated ground to the curved plate of the saddle to hold the saddle in place at the underground pipe.

19. The method of claim 18, wherein the first side of the curved plate includes a generally circular channel extending into the first side, and further comprising providing an adhesive between the saddle and the underground pipe and comprising positioning a seal in the channel at the first side of the saddle to mitigate leaking.

20. The method of claim 19, wherein the seal comprises a hydrophilic O-ring.

21. A system for providing access to an underground pipe, comprising:
a curved plate and a boss extending from the curved plate;
wherein the curved plate has a first side facing the underground pipe and a second side away from the underground pipe; and
wherein the first side of the curved plate includes a generally circular channel extending into the first side.

22. The system of claim 21, further comprising a seal in the channel at the first side of the saddle to mitigate leaking.

23. The system of claim 22, wherein the seal comprises a hydrophilic material.

24. The system of claim 22, wherein the seal comprises a hydrophilic O-ring.

25. The system of claim 21, wherein the curved plate includes outwardly flared flanges at ends thereof.
